(19) United States
(12) Patent Application Publication
(10) Pub. No.: US 2014/0057574 A1
(43) Pub. Date: Feb. 27, 2014

(54) METHOD AND APPARATUS FOR CONTROLLING RECEIVE VOLUME IN A TWO-WAY RADIO SYSTEM

(71) Applicants: Daniel A. Tealdi, Plantation, FL (US); William R. Williams, Coral Springs, FL (US)

(72) Inventors: Daniel A. Tealdi, Plantation, FL (US); William R. Williams, Coral Springs, FL (US)

(73) Assignee: MOTOROLA SOLUTIONS, INC., SCHAUMBURG, IL (US)

(21) Appl. No.: 13/594,258

(22) Filed: Aug. 24, 2012

(51) Int. Cl. H04B 1/44; H04B 7/005

(52) U.S. Cl. 455/69; 455/78

(57) ABSTRACT

A method and apparatus for controlling audio volume in a two-way radio device system (100) can include playing an audio signal over a speaker (112) while a transceiver (102) is receiving the audio signal, and detecting an actuation of a push to talk switch (116) while playing the audio signal. Responsive to detecting actuation of the PTT switch while receiving the audio signal, adjusting a volume at which the audio signal is played over the speaker.

### FIELD OF THE DISCLOSURE

The present disclosure relates generally to two-way radios and more particularly to controlling the speaker volume of audio received by a two-way radio.

### BACKGROUND

Two-way radios and two-way radio systems are used by a wide variety of people and organizations because of their simple operation and immediacy of communication. The term “two-way radio” refers to a radio communication device that plays received audio signals, as they are received, over a speaker, and which allow a user to transmit audio by pressing a “push to talk” (PTT) button and speaking into the device. Such radios are in widespread use, particularly in public safety organizations. The user of the two-way radio that is receiving typically does not have to hold the device to the user's ear to hear the received audio, as in a cellular phone, and the user does not have to “answer” a transmission, rather it is simply received and played over the speaker for the user to hear. As such, two-way radios are useful in situations where immediacy of communication and one-to-many communication are beneficial, such as in emergency response operations. When a user depresses or otherwise actuates the PTT button, the radio can begin transmitting the user's voice as the user speaks into the device, or a connected audio accessory. Sophisticated two-way radios will first check if the selected transmission channel is clear and audibly indicate if/when the channel is clear so that the user does not transmit over other transmissions on the channel.

Public safety organizations, such as police, fire, and rescue organizations have come to rely on two-way radio communication, using both portable, hand-held radios as well as vehicular mounted radios. Typically each public safety user (police, fire, rescue, etc.) will carry a portable two-way radio device system including a portable two-way radio and connected accessories. These mobile units are often called “hand held,” however it is common for a user to put the mobile unit on a belt and listen to received transmissions. Often users have a remote audio device, that couples to the mobile unit, that they will wear on their chest/lapel. The remote audio unit typically contains a speaker, microphone, and PTT button. Furthermore, many two-way radio users are deployed in loud, noisy environments. This is particularly true of fire fighters. Consequently, it is not uncommon for users to set their speaker volume to maximum or near maximum volume level. This can create an issue when several users, such as a team or squad, are congregated together and one of the users begins transmitting. The other nearby users will have their two-way radios set to the same channel as the transmitting user, causing their radios to receive the transmitted signal. Being in close proximity and having their volume set to a loud level, feedback can result.

To mitigate feedback, users will typically take some action other than reducing the volume setting of the speaker, such as covering the speaker with their hand, or turning away from the user who is presently transmitting (and standing in close proximity). Neither of these actions, when engaged in responding to an emergency situation, are particularly desirable. Accordingly, there is a need for a method and apparatus for controlling receive volume in a two-way radio system.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a two-way radio device system in accordance with some embodiments;

FIG. 2 is a block system diagram of a two-radio device system in accordance with some embodiments;

FIG. 3 is a state diagram of operation of volume control in accordance with some embodiments; and

FIG. 4 is a flowchart of a method of controlling a receiving audio volume level in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Embodiments described herein can include two-way radio device system having a two-way radio having a transceiver and further including a push to talk (PTT) switch operable to cause the two-way radio to transmit a radio signal via the transceiver responsive to the PTT switch being closed while the two-way radio is not in a receive mode. The two-way radio device system can further include an audio processor coupled to the transceiver that is configured to receive a demodulated audio signal from the transceiver when the two-way radio is in the receive mode and play the demodulated audio signal over a speaker at a selected volume level. The two-way radio device system can also include the audio processor being further configured to change the selected volume level in response to the PTT switch being actuated when the two-way radio is in the receive mode.

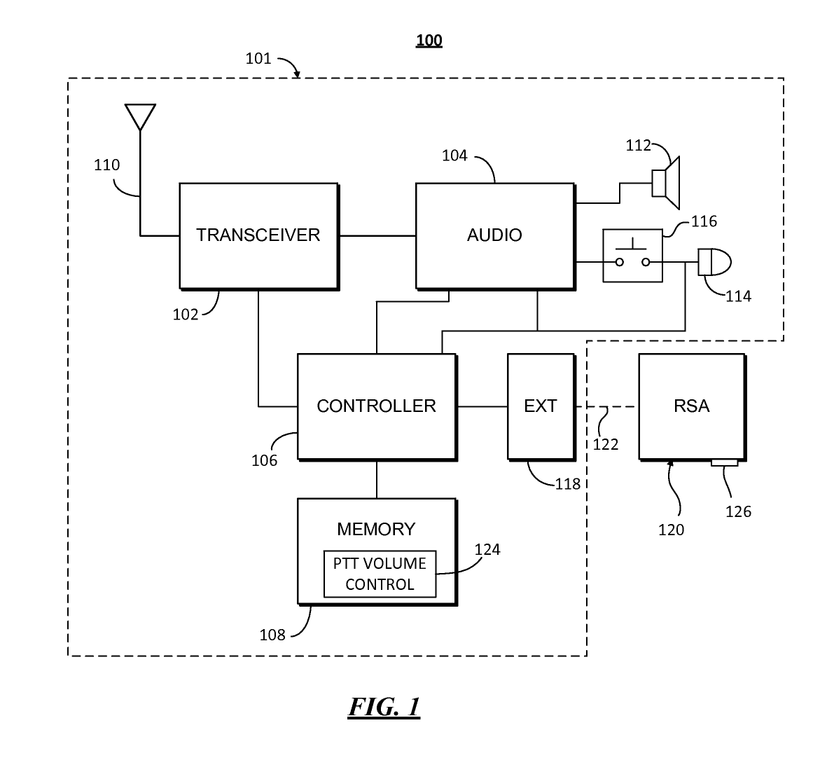

FIG. 1 is a block diagram of a two-way radio device system 100 in accordance with some embodiments. The present exemplary two-way radio system 100 includes a two-way radio 101 and a remote speaker accessory 120. The two-way radio 101 represents any of a variety of general two-way radio configurations, as will be appreciated by those skilled in the art and familiar with two-way radio design. The two-way radio 101 includes a transceiver 102 that, among other functions, receives and transmits modulated radio signals, which can be facilitated with an antenna 110. The transceiver contains circuitry and circuit elements to perform the necessary modulation, demodulation, amplification, filtering, frequency generation, and so on, that are commonly performed by transceivers. Generally an audio processor 104 or audio circuit is operably coupled to the transceiver and provides audio signals to the transceiver that are to be modulated and transmitted, and receives demodulated audio signals from the transceiver that are to be played. The two-way radio 101 can further include a controller 106 that can be one or more microprocessors or similar components. The controller 106 can be operably coupled to the transceiver 102 and audio processor 104, and can coordinate operation of the two-way radio device, such as responsive to certain user interface elements. User interface elements can include buttons, knobs, dials, keypads, and so on. The controller 106 can also output information visually, such as by a graphic display, as is well known. The controller 106 can be operably coupled to a memory 108 that can include one or more types of memory, including read only memory (ROM), random access memory (RAM), flash memory, and other known memory types. A part of memory 108 can contain instruction code that can be executed by controller 106 to implement the desired functionality and operation of the two-way radio 100.

The audio circuitry or audio processor 104 is coupled to at least one speaker 112 and a microphone 114 of the two-way radio 101, and includes any circuitry necessary to provide an electrical audio signal to the speaker 112, and receive an electrical audio signal from microphone 114. In some embodiments the audio processor 104 can receive a digital audio signal from the transceiver 102 and convert the digital audio signal into an analog audio signal that is provided to the speaker at a selected power level corresponding to volume level. The audio processor 104, in some embodiments, can also amplify an analog audio signal from the microphone 114 and convert it into a digital signal, and provide the digitized signal to the transceiver 102 for transmission. The audio processor 104 plays audio signals over the speaker 112, which converts the audio signals from electrical signals to acoustic signals that can be heard by the user of the two-way radio 100 (and those in sufficient proximity to the user). The microphone 114 can be operably coupled to the audio processor 104 through a PTT switch 116 which applies a voltage to the microphone 114 when the PTT switch 116 is closed, such as upon actuating a PTT button or similar transmit interface element that is mechanically coupled to the PTT switch 116. Upon the voltage being applied to the microphone 114, acoustic signals incident on the microphone 114 produce a corresponding electrical audio signal that can be processed by the audio processor 104 and provided to the transceiver 102 for radio transmission. Actuation of the PTT switch 116 can be detected by either the audio processor 104 or the controller 106, for example.

The two-way radio 101 is operated, generally, in one of three modes or states; idle, transmit, or receive. In the idle mode the two-way radio 101 is on and tuned to a selected radio channel or channels, but neither transmitting nor receiving. If the user actuates or “keys” the PTT switch 116 from the idle mode, such as by depressing a PTT button, closing PTT switch 116, the two-way radio 101 will begin to transmit, and continue to transmit as long as the PTT button is depressed, as is conventional PTT operation. If the two-way radio 101 detects the presence of a signal in a monitored channel while the two-way radio is in idle mode, it will change to a receive mode and commence demodulating the signal (via transceiver 102) to obtain the transmitted audio (or other) signal and the received audio signal over speaker 112 (or another speaker).

While in the receive mode, however, embodiments of the invention allow the user to change the volume level of the played audio signal by actuating the PTT switch 116. For example, the controller 106, by executing a PTT volume control instruction code 124, for example, can determine that the two-way radio 101 is in receive mode, and that the PTT switch 116 has been actuated while receiving an audio signal. In response, the controller 106 can cause the audio processor 104 to change the volume at which the received audio signal is played over the speaker 112, for example. In some embodiments actuation of the PTT switch 116 while receiving an audio signal can cause the two-way radio 101 to reduce the volume level from an initial preselected level to a lower level. The reduction can be to a preset level, or by a preset amount. In another embodiment actuation of the PTT switch 116 while receiving an audio signal can cause the two-way radio 101 to increase the volume of the audio being played over the speaker 112. In other embodiments different types of actuations of the PTT switch 116, such as single short press, or double short presses, for example, can cause the two-way radio to lower or increase the volume, respectively. A long press (press and hold) can cause the radio to begin transmitting regardless of the channel status or two-way radio mode.

Accordingly, the term “actuation,” as used here, refers to pressing the PTT button and causing the PTT switch 116 to electrically close, or otherwise indicate to the two-way radio that the PTT button has been pressed (or “depressed”) by the user, followed by a period of holding the PTT switch 116 closed. The user at some point then releases the PTT button, causing the PTT switch to open. For example, to transmit, from an idle mode, the user typically presses and holds the PTT button down for an indeterminate time while talking. When the user releases the PTT button during the transmit mode, the two-way radio will cease transmitting and return to the idle mode. Thus, pressing and holding the PTT button for an indefinite time (to transmit) is one type of actuation. When in the receive mode, however, different types of actuations can be used to indicate different desired actions, such as increasing or decreasing the audio volume level, as indicated by a first type of actuation and a second type of actuation, respectively. For example, a first type of actuation in the receive mode can be defined by detecting closure of the PTT switch 116 for more than a minimum time period and less than a pre-selected period, such as to detect a momentary press (press and release) of the PTT button. A second type of actuation in the receive mode can be defined as a second press occurring within a pre-selected time period of the first actuation ending (e.g. PTT switch 116 opened), followed by the PTT switch 116 again being released within a pre-selected time.

The two-way radio 101 can be part of the two-way radio device system 100 that includes the two-way radio 101, and an external audio accessory such as a remote speaker accessory (RSA) 120. The RSA 120 can connect 122 (wired or wirelessly) to the two-way radio 101. A wired connection can be made via an external interface 118, such as a side connector, that contains conductors for power and signals as necessary, and a wireless connection can be made using, for example, a personal area network radio link such as that known by the trade name “Bluetooth.” The RSA 120 can include a speaker and microphone (not shown), and a PTT button/switch 126. The two-way radio system 100 can allow a user to, for example, wear a two-way radio 101 on the user's belt, and have the RSA 120 attached near the user's shoulder, on the user's chest (e.g. on a lapel, pocket, or other part of clothing), on a belt or strap, and so on. As with PTT switch 116 on the two-way radio 101, the PTT button/switch 126 on the RSA 120 can be used while receiving an audio signal that is being played over the speaker of the RSA 120 to change the volume level of the audio being played over the RSA speaker by actuating the PTT button/switch 126 while an audio signal is being played over the speaker of the RSA 120. The audio volume level at the RSA 120 can be controlled by circuitry in the RSA 120, or by the two-way radio controlling the audio signal level provided to the RSA 120 by the two-way radio 101.

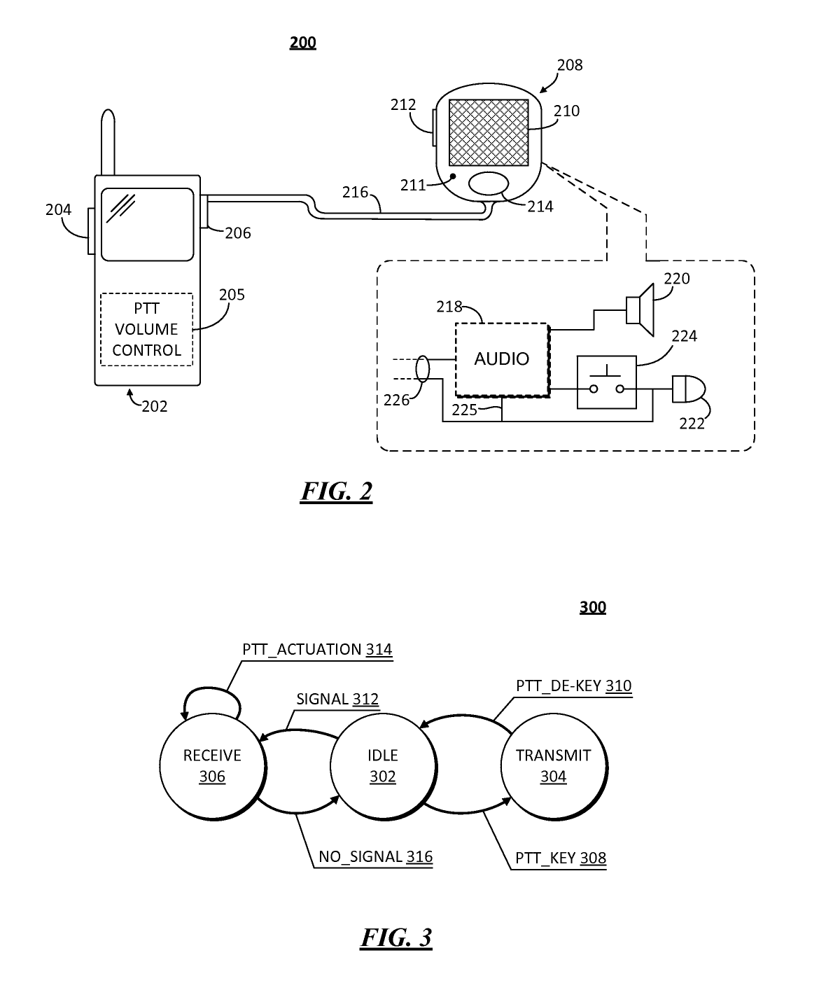

FIG. 2 is a block system diagram of a two-way radio device system 200 in accordance with some embodiments. The device system 200 includes a two-way radio 202 and a RSA 208 that can be attached to the two-way radio 202, for example, via a cable 216 connected to a side connector 206 of the two-way radio 202. The two-way radio 202 includes a PTT button 204 for operating a transmit interface element, such as a PTT button 214 for actuating PTT switch 224. In the exemplary system shown here, the two-way radio 202 can be a portable or hand held two-way radio that can be worn on a user's belt, and the RSA 208 is typically worn closer to the user's head, such as on the user's shoulder or high on the user's chest so that the user can speak into a microphone port 211 when transmitting, and a speaker 220 is nearer the user's ear and can be heard through a speaker port or grill 210. The two-way radio 202 will route received audio signals to the RSA 208 to be played over the speaker 220. Likewise, audio signals from a microphone 222 are routed to the two-way radio 202 for radio transmission by the two-way radio 202.

To facilitate voice transmission, the RSA 208 has a PTT button 214 that the user actuates by pressing to commence transmission and holding the PTT button down (closed) while speaking, which causes PTT switch 224 to be closed while the user holds the PTT button down. In some embodiments when PTT switch 224 is closed, a direct current (DC) voltage is applied to the microphone 222 that can be sensed or otherwise detected, either locally at the RSA 208 or by the two-way radio 202. In some embodiments the PTT switch may not be in series with the microphone and can be independent of the microphone and is sensed separately from the microphone line. In embodiments where the PTT switch is independent of the microphone, the audio processor 218 can simply not provide audio signals from the microphone to the transceiver until and unless the PTT switch is closed and the two-way radio 202 is in a transmit mode. Signals produced by the microphone resulting from sound waves incident on the microphone 222 can be fed back to an audio processor 218 locally in the RSA 208 or an audio processor in the two-way radio 202, through a DC blocking capacitor (not shown) as is known. When the two-way radio 202 detects actuation of the PTT switch 224 on the RSA 208 it can commence transmitting (or indicate the channel is busy). Audio signals can be routed over a set of connections 226 that can be, for example, conductor wires, or in some embodiments, a personal area network radio link. In some embodiments where the RSA 208 contains an audio processor 218 it can locally control volume of audio played over speaker 220. The audio processor 218 can detect actuation of the PTT switch 224 such as by sampling a microphone line 225 and determine if the PTT switch 224 has been actuated while the RSA 208 is receiving an audio signal from the two-way radio 202, and in response the audio processor 218 change the volume of the audio being played over the speaker 220. In such embodiments the audio processor 218 includes a PTT volume control function equivalent to PTT volume control function 205. In some embodiments the PTT switch can be independent of the microphone and sensed separately. In some embodiments there can be several types of actuations that be detected, each one being associated with a different type of volume adjustment (e.g. lower, higher, mute, toggle).

FIG. 3 is a state diagram 300 of operation of volume control in accordance with some embodiments. The state diagram 300 shows, generally, at last three states in which a two-way radio can operate according to embodiments, and how the two-way radio transitions between states, which include an idle state 302, a transmit state 304, and a receive state 306. In the idle state 302 a two-way radio is powered on and monitoring one or more channels, but is neither transmitting nor receiving radio signals. From the idle state 302, the two-way radio can transition to the transmit state 304 in response to the user actuating a PTT button, or “key,” generating a PTT_KEY event 308. In response, the two-way radio can commence transmitting audio signals produced at a microphone. In some embodiments the two-way radio can first acquire a channel, and then give the user an indication that the user can then speak, while the user is keying the PTT button. When the user is finished talking, the user can release the PTT button, generating a PTT_DE-KEY event 310, causing the two-way radio to transition back to the idle state 320 from the transmit state 304. From the idle state 302, the two-way radio can transition to the receive state 306 upon detection of a signal on a monitored channel intended for the two-way radio, which can produce a SIGNAL event 312. In response, the two-way radio will commence providing demodulated audio to a speaker so that the user can hear the received audio signal. While in the receive mode, i.e. while obtaining demodulated audio from a monitored channel, the user can actuate the PTT button, resulting in a PTT_ACTUATION event 314. In response, the two-way radio can adjust the volume of the audio being played over the speaker. The PTT_ACTUATION event 314 can be one of a plurality of defined types of actuation, where each actuation type corresponds to a different volume adjustment. For example, a single momentary press (press and release within a short time) of the PTT button can cause the two-way radio to decrease the audio volume, while a double momentary press can cause the two-way radio to increase the volume. In some embodiments actuating the PTT button can cause the two-way radio to toggle the audio volume between a low and a high volume level. In some embodiments a particular PTT actuation type can cause the two-way radio to mute the audio so that no audio is played over the speaker. Other types of audio adjustment can be defined as well, such as stepping the volume up or down in successive increments in response to repeated PTT actuations of the same type. The two-way radio can leave the receive state 306 in response to there being no signal (NO_SIGNAL event 316) in the monitored channel that the two-way radio was receiving, i.e. when the signal ends. In transitioning back to the idle state 302, the two-way radio can reset the audio volume level to a pre-selected audio volume level, such as one corresponding to a setting of a volume control knob, so that the next time a signal is received the audio will be played at the pre-selected audio volume until and unless the user actuates the PTT button while the two-way radio is in the receive state. It will be appreciated by those skilled in the art that the labels used to describe events here, such as, for example, PTT_ACTUATION event 314, are meant only to describe a general occurrence of an action or event that the device is designed to detect, and not to limit the invention to specific event labels. Numerous variations of the general processes described here as events will occur to those skilled in the art that fall within in the scope of the embodiments taught herein.

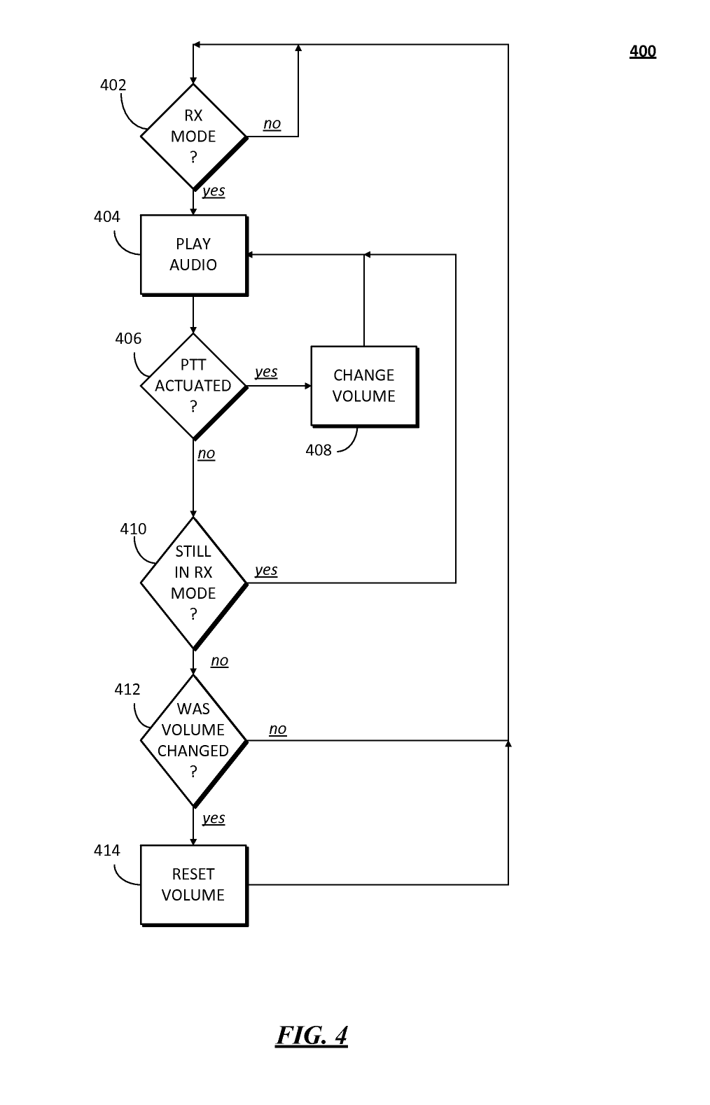

FIG. 4 is a flowchart of a method 400 of controlling a receiving audio volume level in accordance with some embodiments. The method 400 exemplified by the flowchart represents some general embodiments of the inventive method 400, and variations within the scope of the embodiments taught and claimed herein will occur to those skilled in the art. The method is abstracted here into several processes represented by the boxes shown in the flowchart diagram. Each process can have one or more subprocesses. The method 400 can start with the two-way radio in an idle state, monitoring one or more selected radio channels. Once the two-way radio detects a signal intended for the two-way radio, it will be in the receive mode (402). Once in the receive mode, the two-way radio will then commence playing audio (404) received over the channel, which is obtained by, for example, demodulating the received radio signal. While receiving the audio signal, the two-way radio determines if the PTT button has been actuated (406) and whether a signal is still being received (410). If the PTT button, or other transmit interface element, has been actuated, the two-way radio adjusts the audio volume level (408). The adjustment, in a first iteration of the method 400, can be from an initial, pre-selected volume level (e.g. a volume level corresponding to a setting of a volume knob) to a different audio volume level. The adjustment can increase or decrease the volume level, and the adjustment can correspond with an actuation type, where more than one type of PTT actuation has been defined, each type of actuation corresponding to an adjustment type (e.g. a first type of actuation for increasing volume, a second type of actuation for decreasing the volume). When the two-way radio is no longer receiving, the method 400 can determine if the volume had been adjusted while receiving (412), and if so, reset the volume level back to an initial or pre-selected level (414). If the volume was not adjusted, the method 400 returns to an idle mode and begins monitoring the selected channel or channels (402).

As is suggested by the flowchart, the method 400 can be performed iteratively between processes 404, 406, 408, and 410, where the audio volume can be adjusted and played as an adjusted volume for one iteration, and the adjusted volume will be an initial or selected volume level for a successive iteration of the method. In some embodiments the volume level can be toggled between a high volume level and low volume level by actuation the PTT switch.

Those of skill in the art will appreciate the various ways in which a PTT actuation can be detected, and how various types of PTT actuations can be determined. For example, a timer can be used to determine short actuations (referring to the time between pressing and releasing the PTT button), and long actuations. Furthermore, a timer and a count can be used to determine a number of actuations.

Accordingly, there has been provided an apparatus and method for controlling the volume of an audio signal being played over a speaker while a two-way radio is in a receive mode. The disclosed teachings are particularly beneficial to two-way radio device systems used in public safety environments as the users of such disclosed systems can easily adjust the audio volume level of their own system when, for example, standing next to the person who is producing (talking) the audio being received by the user so as to avoid feedback.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A two-way radio device system having a transceiver, comprising:
a push to talk (PTT) switch operable to cause a two-way radio to transmit a radio signal responsive to the PTT switch being closed while the two-way radio is not in a receive mode;
an audio processor coupled to the transceiver configured to receive a demodulated audio signal from the transceiver when the two-way radio is in the receive mode and play the demodulated audio signal over a speaker at a volume level; and
the audio processor is further configured to change the volume level in response to the PTT switch being actuated when the two-way radio is in the receive mode.

2. The two-way radio device system of claim 1, wherein the audio processor is further configured to reset the volume level to an initial volume level in response to exiting the receive mode.

3. The two-way radio device system of claim 1, wherein the audio processor is configured to mute the volume level in response to the PTT switch being actuated when the two-way radio is in the receive mode.

4. The two-way radio device system of claim 1, wherein the audio processor is configured to lower the volume level in response to the PTT switch being actuated when the two-way radio is in the receive mode.

5. The two-way radio device system of claim 1, wherein the audio processor is configured to raise the volume level in response to the PTT switch being actuated when the two-way radio is in the receive mode.

6. The two-way radio device system of claim 1, wherein the audio processor is configured to alternately toggle the volume level between a low volume level and a high volume level in response to the PTT switch being actuated when the two-way radio is in the receive mode.

7. The two-way radio device system of claim 1, wherein the PTT switch and the speaker are disposed in an audio accessory coupled to a two-way radio handset, and the transceiver is disposed in the two-way radio.

8. The two-way radio device system of claim 1, wherein the PTT switch is operable to cause a two-way radio to enter a transmit mode and transmit the radio signal responsive to the PTT switch being closed while the two-way radio is in an idle mode, and to remain in the transmit mode while the PTT switch remains closed.

9. A method of controlling audio volume in a two-way radio device system, comprising:
receiving an audio signal from a radio transceiver of a two-way radio;
playing the audio signal over a speaker at an initial volume level while receiving the audio signal;
detecting a user actuation of a push to talk (PTT) switch while playing the audio signal, wherein the PTT switch is operable to cause the radio transceiver to transmit when the two-way radio is not in a receive mode;
in response to detecting the user actuation of the PTT switch while playing the audio signal, changing the initial volume level to an adjusted volume level and continuing to play the audio signal at the adjusted volume level while receiving the audio signal.

10. The method of claim 9, wherein changing the initial volume level comprises reducing the volume level.

11. The method of claim 9, wherein changing the initial volume level comprises increasing the volume level.

12. The method of claim 9, wherein changing the initial volume level comprises muting the volume level.

13. The method of claim 9, wherein detecting the user actuation of the PTT button comprises detecting the user actuation of a PTT switch of a remote speaker accessory that is coupled to a two-way radio.

14. The method of claim 13, wherein detecting the user actuation of the PTT switch of the remote speaker assembly is performed by an audio processor of the remote speaker accessory, and changing the initial volume level is performed by the audio processor of the remote speaker accessory.

15. The method of claim 9, wherein receiving the audio signal ends, and in response the method further comprises resetting the adjusted volume level to the initial volume level.

16. An apparatus, comprising:
a speaker;
a microphone;
a push to talk (PTT) switch operable to activate the microphone and cause a two-way radio to commence transmitting a radio signal including signal produced by the microphone when the two-way radio is not in a receive mode; and
an audio processor configured to receive an audio signal and play the audio signal over the speaker while receiving the audio signal, the audio signal is initially played at an initial volume level, and the audio processor is further configured to adjust the initial volume level to an adjusted volume level while playing the audio signal in response to an actuation of the PTT switch during the receive mode, and reset the volume adjusted level to the initial volume level in response to the receive mode ending.

17. The apparatus of claim 16, wherein the speaker and PTT button are disposed in a remote speaker accessory.

18. The apparatus of claim 17, wherein the audio processor is disposed in the remote speaker accessory.

19. The apparatus of claim 16, wherein the adjusted volume level is lower than the initial volume level.

20. The apparatus of claim 16, wherein the actuation of the PTT switch during the receive mode is one of a plurality of types of PTT switch actuations, each of the plurality of types of PTT switch actuations corresponding to a different type of adjustment of the initial volume.

21. The apparatus of claim 20, wherein the plurality of types of PTT switch actuations include a single press actuation and a double press actuation.
